(19) United States
(12) Patent Application Publication
(10) Pub. No.: US 2014/0078947 A1
(43) Pub. Date: Mar. 20, 2014

(54) APPARATUS AND METHOD FOR IMPROVING ENERGY EFFICIENCY OF SENSOR NETWORK SYSTEM

(71) Applicant: Electronics and Telecommunications Research Institute, Daejeon (KR)

(72) Inventors: Hae Yong KIM, Daejeon (KR); Jong Soo JEONG, Daejeon (KR); Seon Tae KIM, Daejeon (KR)

(21) Appl. No.: 13/927,050

(22) Filed: Jun. 25, 2013

(30) Foreign Application Priority Data
Sep. 19, 2012 (KR) 10-2012-0103912

(51) Int. Cl. H04W 52/02

(52) U.S. Cl. CPC H04W 52/0209
USPC 370/311

(57) ABSTRACT

Provided is an apparatus and method for setting an operation of a sensor node based on an amount of energy of the sensor node. A sensor node of a wireless sensor network system may include an energy identifier to identify an amount of energy of the sensor node; and a node setting unit to set the sensor node as one of a router node that relays communication with a neighbor node and a leaf node that does not relay the communication, based on the amount of energy of the sensor node.

### CROSS-REFERENCE TO RELATED APPLICATION

This application claims the priority benefit of Korean Patent Application No. 10-2012-0103912, filed on Sep. 19, 2012, in the Korean Intellectual Property Office, the disclosure of which is incorporated herein by reference.

### BACKGROUND

1. Field of the Invention

The present invention relates to an apparatus and method for enhancing energy efficiency of a sensor network system, and more particularly, to an apparatus and method for decreasing an amount of energy used by a sensor node of which an amount of remaining energy is relatively small compared to an amount of energy of a neighbor node, by switching setting of the sensor node between a router node and a leaf node based on the amount of energy of the sensor node.

2. Description of the Related Art

A sensor network system refers to a network system that includes a plurality of sensor nodes, and may be configured to collect information generated in each sensor node using at least one synchronization (sync) node. Here, the sensor network system may be configured as a topology in a tree form in which the plurality of sensor nodes is arranged hierarchically over distance based on the sync node.

A sensor node set as a router node needs to transmit, to the sync node, information about the sensor node and information that is transmitted from a child node of the sensor node in a lower layer on the tree-formed topology and thus, may use a large amount of energy. On the contrary, a sensor node that is positioned at a lower end of the tree-formed topology and thus, is set as a leaf node having no child node may transmit only information about the sensor node to the sync node and thus, may use a relatively small amount of energy compared to the router node.

Accordingly, the conventional sensor network system may group sensor nodes included in a sensor network and alternately set sensor nodes included in each group as a routing node, thereby saving energy.

However, the conventional sensor network system may be employed in a case in which sensor nodes are arranged at a very high density and thus, a communication issue resulting from grouping may occur.

Accordingly, there is a need for a method that may have relatively small constraints in terms of use conditions and may prevent the energy of a sensor node set as a router node from being depleted.

### SUMMARY

An aspect of the present invention provides an apparatus and method that may decrease an amount of energy used by a sensor node of which an amount of remaining energy is relatively small compared to an amount of energy of a neighbor node by switching setting of the sensor node between a router node and a leaf node, based on whether the amount of remaining energy of the sensor node included in a sensor network is relatively small.

According to an aspect of the present invention, there is provided a sensor node of a wireless sensor network system, the sensor node including: an energy identifier to identify an amount of energy of the sensor node; and a node setting unit to set the sensor node as one of a router node that relays communication with a neighbor node and a leaf node that does not relay the communication, based on the amount of energy of the sensor node.

The node setting unit of the sensor node may set the sensor node as one of the router node and the leaf node based on a result of comparing the amount of energy of the sensor node and an amount of energy of a neighbor node of the sensor node.

The sensor node may further include a node designator to designate a preliminary parent node of the sensor node capable of replacing a parent node of the sensor node among neighbor nodes of the sensor node.

The node setting unit of the sensor node may set the sensor node as one of the router node and the leaf node, based on whether a child node of the sensor node designates a preliminary parent node of the child node capable of replacing the sensor node and the amount of energy of the sensor node.

The node setting unit of the sensor node may set the sensor node as one of the router node and the leaf node based on the number of neighbor nodes that are set as the leaf node among neighbor nodes of a child node of the sensor node, and the amount of energy of the sensor node.

The node setting unit of the sensor node may set, as the router node, a neighbor node that is set as the leaf node among neighbor nodes of a child node of the sensor node, based on the amount of energy of the sensor node.

When the sensor node is set as the router node or the leaf node, the node setting unit of the sensor node may inform a neighbor node of the sensor node about setting of the sensor node.

When a child node of the sensor node is not selected during a predetermined period of time after the sensor node is initialized, the node setting unit of the sensor node may set the sensor node as the leaf node.

According to another aspect of the present invention, there is provided a method of operating a sensor node in a wireless sensor network system, the method including: identifying an amount of energy of the sensor node; and setting the sensor node as one of a router node that relays communication with a neighbor node and a leaf node that does not relay the communication, based on the amount of energy of the sensor node.

According to embodiments of the present invention, when an amount of remaining energy of a sensor node, operating as a router node that relays communication between neighbor nodes, is relatively small compared to an amount of energy of the neighbor nodes, it is possible to decrease an amount of energy used by the sensor node of which the amount of remaining energy is relatively small, by switching setting of the sensor node from the router node to a leaf node that does not relay communication.

Also, according to embodiments of the present invention, by changing a sensor node of which an amount of remaining energy is relatively small compared to energy of a neighbor node with a leaf node among sensor nodes operating as a router node and by changing m another sensor node that operates as a leaf node with a new router node, an energy node having a relatively large amount of remaining energy for communication may operate as the router node, thereby stabilizing a communication network of a sensor network.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a wireless sensor network system according to an embodiment of the present invention;

FIG. 2 is a block diagram illustrating a sensor node according to an embodiment of the present invention;

FIGS. 3A and 3B are diagrams illustrating an operation of a sensor network according to an embodiment of the present invention;

FIG. 4 is a flowchart illustrating a method of configuring a sensor network according to an embodiment of the present invention;

FIG. 5 is a flowchart illustrating an operation method of a sensor node according to an embodiment of the present invention; and

FIG. 6 is a flowchart illustrating an operation of setting a sensor node as a leaf node of FIG. 5 according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

A routing method of a wireless sensor network system according to an embodiment of the present invention may be performed by sensor nodes included in the wireless sensor network system.

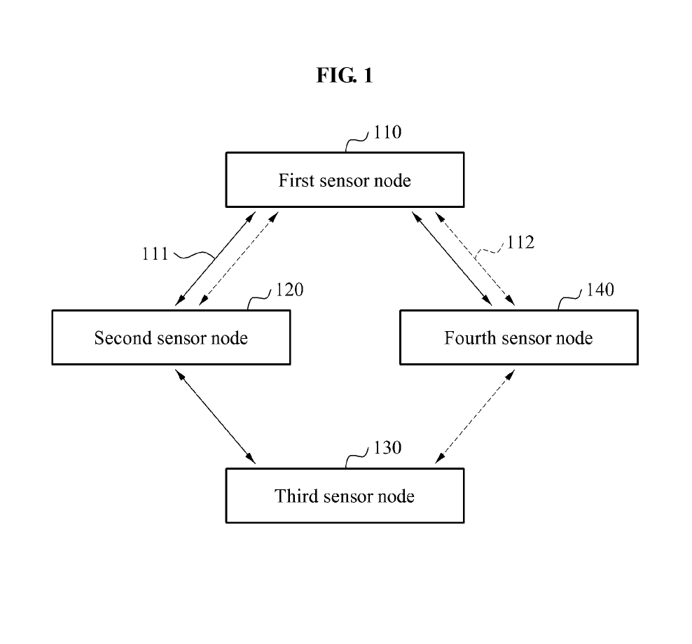

FIG. 1 is a diagram illustrating a wireless sensor network system according to an embodiment of the present invention.

The wireless sensor network system according to an embodiment of the present invention may include a plurality of sensor nodes. Here, each of the sensor nodes may operate as one of a synchronization (sync) node, a router node that relays communication between neighbor nodes of a sensor node, and a leaf node that performs only transmission without relaying the communication. A sensor node may refer to a measurement apparatus that measures peripheral information about a place at which the sensor node is installed and transmits the measured information. Here, the sensor node may store energy used for communication aimed to transmit the measured information.

Referring to FIG. 1, the wireless sensor network system may include a first sensor node 110, a second sensor node 120, a third sensor node 130, and a fourth sensor node 140.

The first sensor node 110 may refer to a sensor node that is set as a sync node configured to receive information measured by the second sensor node 120, the third sensor node 130, and the fourth sensor node 140.

The second sensor node 120 may refer to a sensor node that is set as a router node configured to relay information received from the third sensor node 140 to the first sensor node 110.

The third sensor node 130 may refer to a sensor node that is set as a leaf node configured to transmit, to the second sensor node 120, information measured using a sensor. Also, the fourth sensor node 140 may refer to a sensor node that is set as a leaf node configured to transmit, to the first sensor node 110, information measured using a sensor.

Here, in operation 111, the second sensor node 120 may relay, to the first sensor node 110, information received from the third sensor node 130 as well as information measured by the second sensor node 120. For example, the second sensor node 120 may transmit, to the first sensor node 110, information measured by the second sensor node 120 and information measured by the third sensor node 130 and thus, may perform transmission a relatively large number of times and use a relatively large amount of energy in order to transmit the information, compared to the fourth sensor node 140 configured to transmit only information measured by the fourth sensor node 140 to the first sensor node 110. Accordingly, over time, an amount of energy stored in the second sensor node 120 may become to be less than an amount of energy stored in the fourth sensor node 140.

When the amount of energy stored in the second sensor node 120 is less than the amount of energy stored in the fourth sensor node 140, setting of the second sensor node 120 may be changed from a router node using a large amount of energy to a leaf node. Here, the third sensor node 130 may require a router node in order to transmit the measured information to the first sensor node 110. Accordingly, by changing setting of the fourth sensor node 140 having a relatively large amount of stored energy from the leaf node to the router node, the fourth sensor node 140 may relay, to the first sensor node 110, information measured by the third sensor node 130 in operation 112.

A sensor network system according to an embodiment of the present invention may be switched to a router node using a relatively large amount of energy, based on an amount of energy stored in each sensor node. By using an equivalent amount of energy stored in the sensor nodes, the sensor network system may prevent malfunction from occurring in a sensor network due to depleted energy of a sensor node operating as a router node, despite of the presence of a sensor node of which energy is not depleted.

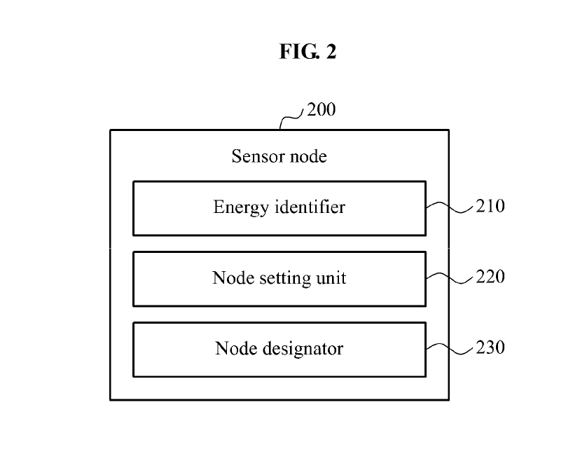

FIG. 2 is a block diagram illustrating a sensor node 200 according to an embodiment of the present invention.

Referring to FIG. 2, the sensor node 200 according to an embodiment of the present invention may include an energy identifier 210, a node setting unit 220, and a node designator 230. Here, the sensor node 200 may be a sensor node included in a sensor network system, such as the first sensor node 110, the second sensor node 120, the third sensor node 130, and the fourth sensor node 140, for example.

The energy identifier 210 may identify an amount of energy of the sensor node 200. Also, the energy identifier 210 may identify an amount of energy of each of neighbor nodes that are positioned within a predetermined distance from the sensor node 200. Here, the predetermined distance may be, for example, a single hop or two hops.

The energy identifier 210 may identify an amount of energy available by the sensor node 200 for communication. The energy identifier 210 may transmit, to neighbor nodes of the sensor node 200, information associated with the identified amount of energy remaining in the sensor node 200. Also, the energy identifier 210 may receive information associated with amounts of energy of the neighbor nodes from the neighbor nodes of the sensor node 200.

The node setting unit 220 may set the sensor node 200 as one of a router node relaying communication between the neighbor nodes and a leaf node that does not relay the communication, based on the amount of energy of the sensor node 200 identified by the energy identifier 210.

Here, the node setting unit 220 may set the sensor node as one of the router node and the leaf node based on a result of comparing the amount of energy of the sensor node 200 and an amount of energy of a neighbor node. For example, when the amount of energy of the sensor node 200 is less than the amount of energy of the neighbor node, the node setting unit 220 may determine that the energy of the sensor node 200 is being depleted. Accordingly, the node sensor 200 may set the sensor node 200 as a leaf node using a relatively small amount of energy.

Also, the node setting unit 220 may set the sensor node 200 as one of the router node and the leaf node based on whether a child node of the sensor node 200 designates a preliminary parent node of the child node capable of replacing the sensor node 200, and the amount of energy of the sensor node 200. Here, the child node of the sensor node 200 may designate, as the preliminary parent node of the child node, at least one of neighbor nodes set as a router node. For example, the child node of the sensor node 200 may designate, as the preliminary parent node of the child node, a neighbor node having the smallest number of child nodes among the neighbor nodes of the child node.

For example, when an amount of energy of the sensor node 200 is less than an amount of energy of a neighbor node of the sensor node 200, the child node of the sensor node 200 may designate a preliminary parent node of the child node. Here, when the sensor node 200 is set as a leaf node, the child node of the sensor node 200 may use the designated preliminary parent node of the child node as a parent node instead of using the sensor node 200. Accordingly, the node setting unit 220 may set the sensor node 200 as the leaf node. Child nodes of the sensor node 200 may set the preliminary parent node of the child node as the new parent node.

Also, although an amount of energy of the sensor node 200 is less than an amount of energy of a neighbor node of the sensor node 200, the child node of the sensor node 200 may not designate the preliminary parent node of the child node. That is, the child node of the sensor node 200 may not use, as the parent node, another node excluding the sensor node 200.

Here, when the sensor node 200 is set as the leaf node, the child node of the sensor node 200 may have no node to be used as the parent node and thus, may not transmit information. Accordingly, the node setting unit 220 may maintain the sensor node 200 as the router node even though the amount of energy of the sensor node 200 is less than the amount of energy of the neighbor node of the sensor node 200.

The node setting unit 220 may set the sensor node 200 as one of the router node and the leaf node based on the number of neighbor nodes set as a leaf node among the neighbor nodes of the child node of the sensor node 200, and the amount of energy of the sensor node 200. Here, the child node of the sensor node 200 and a neighbor node of the child node may have the same configuration as the sensor node 200. Accordingly, a neighbor node set as a leaf node may also be set as a router node.

When the child node of the sensor node 200 does not designate a preliminary parent node of the child node, neighbor nodes operating as a router node among neighbor nodes of the child node of the sensor node 200 may not become a parent node of the child node of the sensor node 200. Accordingly, the child node of the sensor node 200 may select a parent node from among neighbor nodes that are set as a leaf node and of which energy is not depleted.

Accordingly, the node setting unit 220 may set, as a router node, neighbor nodes that are set as a leaf node among the neighbor nodes of the child node of the sensor node 200. Specifically, the node setting unit 220 may transmit, to neighbor nodes set as a leaf node among neighbor nodes of the child node of the sensor node 200, a message indicating to set the neighbor nodes as a router node. Here, the neighbor nodes set as a leaf node may be switched to be from the leaf node to a router node in response to the received message.

The child node of the sensor node 200 may set a parent node from among neighbor nodes that are set as a router node by the node setting unit 220. Here, the child node of the sensor node 200 may switch, to the leaf node again, neighbor nodes that are unselected as a parent node by child node of the sensor node 200 from among neighbor nodes that have received the message.

That is, when the child node of the sensor node 200 does not designate a preliminary parent node of the child node and the number of neighbor nodes set as a leaf node among neighbor nodes of the child node of the sensor node 200 is “zero”, the child node of the sensor node 200 may not select a parent node that replaces the sensor node 200. Accordingly, even though an amount of energy of the sensor node 200 is less than an amount of energy of the neighbor node of the sensor node 200, the node setting unit 220 may maintain the sensor node 200 as a router node.

Also, when the child node of the sensor node 200 does not designate a preliminary parent node of the child node and the number of neighbor nodes as a leaf node among neighbor nodes of the child node of the sensor node 200 is at least “one”, the child node of the sensor node 200 may select a parent node that replaces the sensor node 200 from among the neighbor nodes set as a leaf node. Accordingly, the node setting unit 220 may set the sensor node 200 as a leaf node, and the child node of the sensor node 200 may use the selected neighbor node as the parent node that replaces the sensor node 200.

When the sensor node 200 is set as one of the router node and the leaf node, the node setting unit 220 may inform the neighbor node of the sensor node 200 about setting of the sensor node 200. Also, the node setting unit 220 may receive setting information of the neighbor nodes from the neighbor nodes of the sensor node 200. That is, the node setting unit 220 may inform neighbor nodes about setting of the sensor node 200, and may receive setting information of the neighbor nodes, thereby identifying, from among the neighbor nodes, a neighbor node set as a leaf node and a neighbor node set as a router node.

Also, when the child node of the sensor node 200 is not selected during a predetermined period of time after the sensor node 200 is initialized, the node setting unit 220 may set the sensor node 200 as the leaf node.

For example, in the case of configuring a sensor network including the sensor node 200, the sensor node 200 may be initialized. Here, the sensor node 200 and all of nodes included in the sensor network may be set as a router node. Each of the sensor node 200 and nodes included in the sensor network may select a parent node capable of relaying communication.

Here, that there is no child node that selects the sensor node 200 as a parent node during a predetermined period of time may indicate that there is no node to use the sensor node 200 as a router node. Accordingly, the node setting unit 220 may set the sensor node 200 as a leaf node that does not relay the communication.

The node designator 230 may designate a preliminary parent node of the sensor node capable of replacing the parent node of the sensor node 200, among neighbor nodes of the sensor node 200. Here, the node designator 230 may operate in a case in which the node setting unit 220 sets the sensor node 200 as a leaf node. For example, the sensor node 200 may designate, as the preliminary parent node of the sensor node, a neighbor node having the smallest number of child nodes among the neighbor nodes of the sensor node 200.

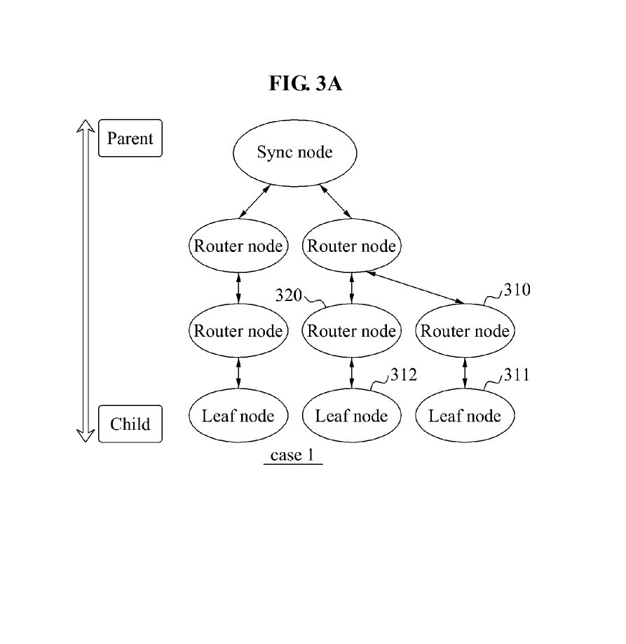

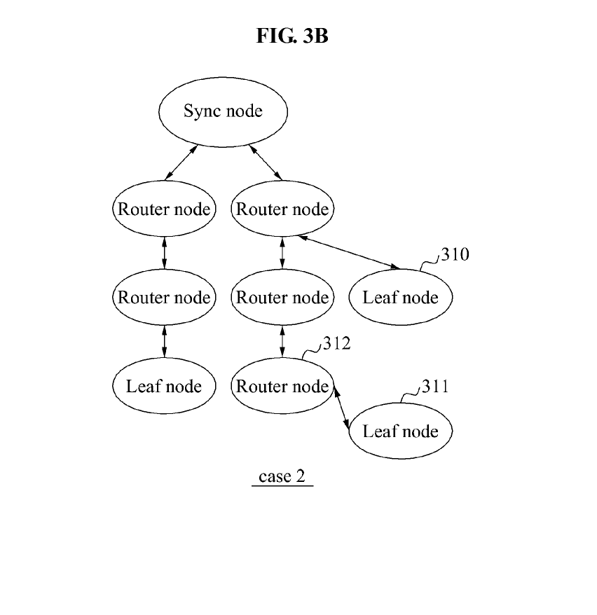

FIGS. 3A and 3B are diagrams illustrating an operation of a sensor network according to an embodiment of the present invention.

FIG. 3A illustrates case 1 in which a sensor node 310 is set as a router node. Here, the sensor node 310 may have, as a child node, a sensor node 311 that is set as a leaf node. Also, a sensor node 312 corresponding to a neighbor node may be present within a predetermined distance from the sensor node 311.

When the number of times that the sensor node 311 performs communication using the sensor node 310 as a router node increases, or when the number of times that the sensor node 310 performs communication increases, an amount of energy of the sensor node 310 may be decreased to be less than an amount of energy of other sensor nodes included in the sensor network.

Here, to minimize a decrease in an amount of remaining energy, the sensor node 310 may be set as a leaf node as illustrated in case 2 of FIG. 3B. The sensor node 311 that was a child node of the sensor node 310 may designate a new parent node.

For example, when an amount of energy of the sensor node 310 is less than an amount of energy of a sensor node 320 that is a neighbor node of the sensor node 310, the sensor node 310 may verify whether the sensor node 311 has designated a preliminary parent node of the sensor node. When the sensor node 311 does not designate the preliminary parent node of the sensor node, the sensor node 310 may switch the sensor node 312 set as a leaf node to be a router node among the neighbor nodes of the sensor node 311.

Here, the sensor node 311 may designate the sensor node 312 switched to the router node, as the parent node that replaces the sensor node 310.

According to an embodiment of the present invention, when an amount of energy of a sensor node set as a router node decreases, a sensor network may change setting of the corresponding sensor node from the router node to a leaf node, and may set a child node of the corresponding sensor node as a child node of another sensor node, thereby maintaining the sensor network and preventing relaying of communication from being suspended due to energy depletion of the router node.

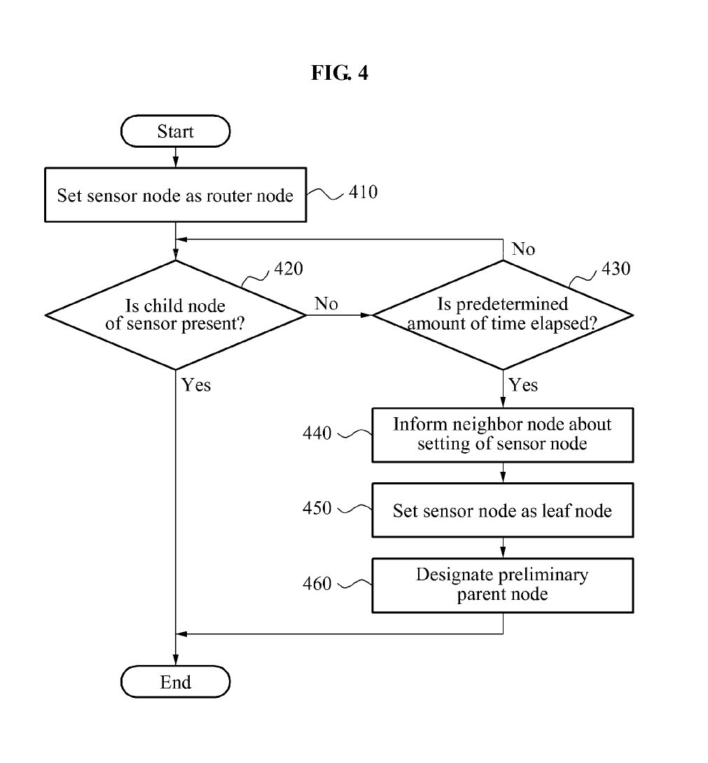

FIG. 4 is a flowchart illustrating a method of configuring a sensor network according to an embodiment of the present invention.

In operation 410, all of the sensor nodes included in a sensor network may set themselves as a router node. Each of the sensor nodes included in the sensor network may designate another sensor node as its parent node based on conditions that include a distance.

In operation 420, each of the sensor nodes included in the sensor network may verify whether there is a child node that designates the corresponding sensor node as a parent node in operation 410. Sensor nodes having a child node may terminate an operation associated with a configuration of the sensor network without performing an additional operation.

In operation 430, a sensor node having no child node may verify whether a predetermined amount of time is elapsed from a point in time when the configuration of the sensor network is initiated. Here, the predetermined amount of time may refer to an amount of time in which all of the sensor nodes included in the sensor network may designate their parent nodes. That is, even though the predetermined amount of time is elapsed, another sensor node selecting the corresponding sensor node as the parent node may be absent in the sensor network. Accordingly, after the predetermined amount of time is elapsed, the sensor node having no child node may be set as a leaf node.

When the predetermined amount of time is not elapsed, the sensor node verified to have no child node may verify whether a child node is added by performing again operation 420.

In operation 440, the sensor node having no child node may inform neighbor nodes of the sensor node that the sensor node is set as a leaf node. Here, the neighbor nodes may indicate all of the sensor nodes that are positioned within a single-hop distance from the sensor node having no child node.

In operation 450, the sensor node having no child node may set the sensor node itself as a leaf node.

In operation 460, the sensor node having no child node may designate, as a preliminary parent node of the sensor node capable of replacing its parent node, at least one of neighbor nodes of the sensor node having no child node.

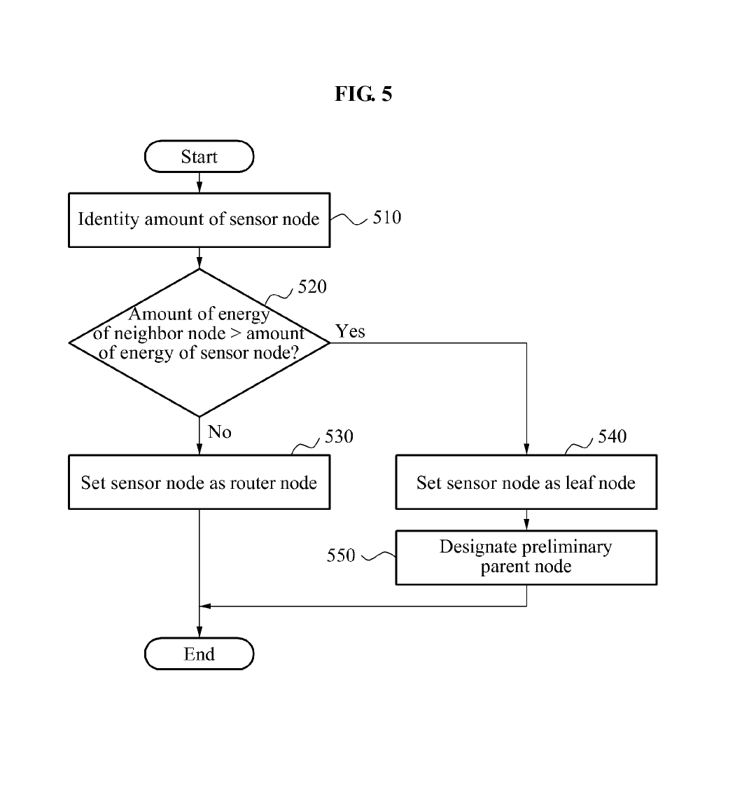

FIG. 5 is a flowchart illustrating an operation method of the sensor node 200 according to an embodiment of the present invention.

In operation 510, the energy identifier 210 may identify an amount of energy of the sensor node 200. Also, the energy identifier 210 may also identify an amount of energy of each of neighbor nodes that are positioned within a predetermined distance from the sensor node 200. Here, the predetermined distance may be a single hop or two hops. Also, the sensor node 200 may be set as a router node as a default value.

For example, the energy identifier 210 may identify an amount of energy available by the sensor node 200 for communication. The energy identifier 210 may transmit, to neighbor nodes of the sensor node 200, information associated with the identified amount of energy remaining in the sensor node 200. Also, the energy identifier 210 may receive information associated with amounts of the energy of the neighbor nodes from the neighbor nodes of the sensor node 200.

In operation 520, the node setting unit 220 may verify whether an amount of energy of the sensor node 200 identified in operation 510 is less than an amount of energy of the neighbor node of the sensor node 200.

When the amount of energy of the sensor node 200 is verified to be greater than the amount of energy of the neighbor node of the sensor node 200 in operation 520, the node setting unit 220 may set the sensor node 200 as a router node in operation 530. That is, the node setting unit 220 may maintain setting of the sensor node 200 that is set as the router node.

On the contrary, when the amount of energy of the sensor node 200 is verified to be less than the amount of energy of the neighbor node of the sensor node 200 in operation 520, the node setting unit 220 may set the sensor node 200 as a leaf node using a relatively small amount of energy in operation 540.

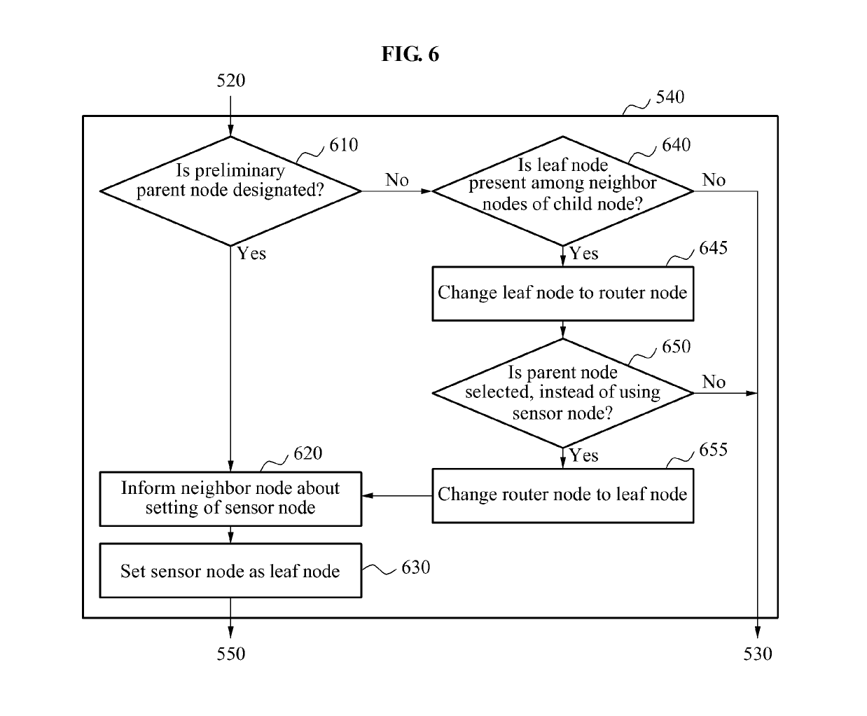

Here, the node setting unit 220 may set the sensor node 200 as a router node by performing operation 530 based on information associated with the child node of the sensor node 200. A process of setting, by the node setting unit 220, the sensor node 200 as the leaf node will be described with reference to FIG. 6.

In operation 550, the sensor node 200 set as the leaf node may designate at least one of neighbor nodes of the sensor node 200 as a preliminary parent node of the sensor node capable of replacing a parent node of the sensor node 200.

FIG. 6 is a flowchart illustrating operation 540 of setting the sensor node 200 as a leaf node of FIG. 5 according to an embodiment of the present invention. Here, operations 610 through 655 may be included in operation 540 of FIG. 5.

In operation 610, the node setting unit 220 may verify whether a child node of the sensor node 200 has designated a preliminary parent node of the child node capable of replacing the sensor node 200.

When the child node of the sensor node 200 designates the preliminary parent node of the child node, and when the sensor node 200 is set as a leaf node, the child node of the sensor node 200 may use the preliminary parent node as a parent node that replaces the sensor node 200.

Accordingly, the node setting unit 220 may determine to set the sensor node 200 as the leaf node, and may perform operation 620.

On the contrary, when the child node of the sensor node 200 is verified to have not designated the preliminary parent node of the child node, the node setting unit 220 may perform operation 640.

In operation 620, the node setting unit 220 may inform the neighbor nodes of the sensor node 200 that the sensor node 200 is set as the leaf node. Here, the neighbor nodes may indicate all of the sensor nodes that are positioned within a single-hop distance from the sensor node having no child node after a predetermined amount of time is elapsed. In operation 630, the node setting unit 220 may set the sensor node 200 as the leaf node. Here, the child nodes of the sensor node 200 may set the preliminary parent node of the child node as a new parent node.

In operation 640, the node setting unit 220 may verify whether a leaf node is present among neighbor nodes of the child node of the sensor node 200.

When a router node capable of adding the child node of the sensor node 200 is absent among the neighbor nodes of the child node of the sensor node 200, the child node of the sensor node 200 may not designate a preliminary parent node of the child node. Accordingly, the node setting unit 220 may select, as a parent node that replaces the sensor node 200, the child node of the sensor node 200 from among leaf nodes having no child node.

That is, when the child node of the sensor node 200 does not designate the preliminary parent node of the child node and when a leaf node is absent among the neighbor nodes of the child node of the sensor node 200, there may be no node that may be used by the child node of the sensor node 200 as a parent node instead of using the sensor node 200.

Accordingly, when no leaf node is verified to be present among the neighbor nodes of the child node of the sensor node 200 in operation 640, the node setting unit 220 may set the sensor node 200 as a router node by performing operation 530.

In operation 645, the node setting unit 220 may set, as a router node, the neighbor nodes of the child node of the sensor node 200 verified in operation 640. The verified neighbor nodes of the child node of the sensor node 200 may be leaf nodes.

In operation 650, the child node of the sensor node 200 may select the parent node from among the neighbor nodes set as the router node in operation 645. Here, when the child node of the sensor node 200 fails to select the parent node, the node setting unit 220 may set the sensor node 200 as the router node by performing operation 530.

On the contrary, when the child node of the sensor node 200 selects the parent node from among the neighbor nodes set as the router node in operation 645, and when the sensor node 200 is set as the leaf node, the child node of the sensor node 200 may use the parent node selected in operation 645 as a new parent node instead of using the sensor node 200. Accordingly, the node setting unit 220 may determine to set the sensor node 200 as the leaf node and perform operation 620. Here, the child node of the sensor node 200 may perform operation 655.

In operation 655, the child node of the sensor node 200 may change, from the router node to the leaf node, setting of remaining sensor nodes excluding the sensor node selected as the parent node from among the neighbor nodes set as the router node in operation 645.

According to embodiments of the present invention, when an amount of remaining energy of a sensor node, operating as a router node that relays communication between neighbor nodes, is relatively small compared to an amount of energy of the neighbor nodes, it is possible to decrease an amount of energy used by the sensor node of which the amount of remaining energy is relatively small, by switching setting of the sensor node from the router node to a leaf node that does not relay communication.

Also, according to embodiments of the present invention, by changing a sensor node of which an amount of remaining energy is relatively small compared to energy of a neighbor node with a leaf node among sensor nodes operating as a router node and by changing another sensor node that operates as a leaf node with a new router node, an energy node having a relatively large amount of remaining energy for communication may operate as the router node, thereby stabilizing a communication network of a sensor network.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A sensor node of a wireless sensor network system, the sensor node comprising:
an energy identifier to identify an amount of energy of the sensor node; and
a node setting unit to set the sensor node as one of a router node that relays communication with a neighbor node and a leaf node that does not relay the communication, based on the amount of energy of the sensor node.

2. The sensor node of claim 1, wherein the node setting unit sets the sensor node as one of the router node and the leaf node based on a result of comparing the amount of energy of the sensor node and an amount of energy of a neighbor node of the sensor node.

3. The sensor node of claim 1, further comprising:
a node designator to designate a preliminary parent node of the sensor node capable of replacing a parent node of the sensor node among neighbor nodes of the sensor node.

4. The sensor node of claim 3, wherein the node setting unit sets the sensor node as one of the router node and the leaf node, based on whether a child node of the sensor node designates a preliminary parent node of the child node capable of replacing the sensor node and the amount of energy of the sensor node.

5. The sensor node of claim 4, wherein when the sensor node is set as the leaf node, the child node changes a parent node of the child node from the sensor node with the preliminary parent node of the child node.

6. The sensor node of claim 1, wherein the node setting unit sets the sensor node as one of the router node and the leaf node based on the number of neighbor nodes that are set as the leaf node among neighbor nodes of a child node of the sensor node, and the amount of energy of the sensor node.

7. The sensor node of claim 1, wherein the node setting unit sets, as the router node, a neighbor node that is set as the leaf node among neighbor nodes of a child node of the sensor node, based on the amount of energy of the sensor node.

8. The sensor node of claim 7, wherein the child node selects a parent node that replaces the sensor node, from among neighbor nodes that are set as the router node by the node setting unit.

9. The sensor node of claim 1, wherein when the sensor node is set as the router node or the leaf node, the node setting unit informs a neighbor node of the sensor node about setting of the sensor node.

10. The sensor node of claim 1, wherein when a child node of the sensor node is not selected during a predetermined period of time after the sensor node is initialized, the node setting unit sets the sensor node as the leaf node.

11. A method of operating a sensor node in a wireless sensor network system, the method comprising:
identifying an amount of energy of the sensor node; and
setting the sensor node as one of a router node that relays communication with a neighbor node and a leaf node that does not relay the communication, based on the amount of energy of the sensor node.

12. The method of claim 11, wherein setting comprises setting the sensor node as one of the router node and the leaf node based on a result of comparing the amount of energy of the sensor node and an amount of energy of a neighbor node of the sensor node.

13. The method of claim 11, further comprising:
designating a preliminary parent node of the sensor node capable of replacing a parent node of the sensor node among neighbor nodes of the sensor node.

14. The method of claim 13, wherein the setting comprises setting the sensor node as one of the router node and the leaf node, based on whether a child node of the sensor node designates a preliminary parent node of the child node capable of replacing the sensor node and the amount of energy of the sensor node.

15. The method of claim 14, wherein when the sensor node is set as the leaf node, the child node changes a parent node of the child node from the sensor node with the preliminary parent node of the child node.

16. The method of claim 11, wherein the setting comprises setting the sensor node as one of the router node and the leaf node based on the number of neighbor nodes that are set as the leaf node among neighbor nodes of a child node of the sensor node, and the amount of energy of the sensor node.

17. The method of claim 11, wherein the setting comprises setting, as the router node, a neighbor node that is set as the leaf node among neighbor nodes of a child node of the sensor node, based on the amount of energy of the sensor node.

18. The method of claim 17, wherein the child node selects a parent node that replaces the sensor node, from among neighbor nodes that are set as the router node in the setting.

19. The method of claim 11, wherein the setting comprises informing a neighbor node of the sensor node about setting of the sensor node when the sensor node is set as the router node or the leaf node.

20. The method of claim 11, wherein the setting comprises setting the sensor node as the leaf node when a child node of the sensor node is not selected during a predetermined period of time after the sensor node is initialized.
